(19) United States
(12) Patent Application Publication
(10) Pub. No.: US 2013/0013383 A1
(43) Pub. Date: Jan. 10, 2013

(54) MOBILE VOUCHER SYSTEM AND METHOD

(75) Inventors: Antonio Vitti, Oakland, CA (US); John Vitti, San Francisco, CA (US)

(73) Assignee: Mobile Spinach, Inc., San Mateo, CA (US)

(21) Appl. No.: 13/178,459

(22) Filed: Jul. 7, 2011

(51) Int. Cl. G06Q 30/00

(52) U.S. Cl. 705/14.16; 705/14.39

(57) ABSTRACT

A system and method for providing mobile vouchers are provided. The mobile voucher system facilitates merchant auto-scaling in which the system is able to scale and acquire merchants. The mobile voucher system also facilitates consumers who can create their own deals/vouchers using the mobile voucher system. The mobile voucher system also facilitates consumer referral rewards where consumers can earn reward points for the purchasing activity of friends in their online social networks.

### APPENDICES

Appendix A (9 pages) show more details of the merchant system of the mobile voucher system; and

Appendix B (13 pages) show more details of teh publisher system of the mobile voucher system, both of which are incorporated herein by reference.

### FIELD

The disclosure relates to a system and method for generating vouchers for a user using a mobile device and in particular to a mobile voucher system that provides merchant auto-scaling, and consumer created deals and consumer referral rewards.

### BACKGROUND

Systems exist that generate and provide paper or virtual coupons on a consumer. For example, Catalina Marketing Corporation provides a system in which coupons, based on the purchasing of products such as at grocery store, are printed on a receipt that is then provided to the consumer. Catalina Marketing Corporation analyzes shoppers' purchases at large national retailers such as supermarkets, pharmacies and other mass merchandise stores. It then presents these shoppers with in-store coupons printed on the back of their paper store receipt that are related to their previous shopping history in that store. While this provides a great mechanism to provide the consumer additional coupons, this system has a few drawbacks. First, it limited to paper delivery on printed receipts and is therefore not digital or interactive. Second, these coupons are limited to the same store of the purchase. Third, these coupons are targeted only to bring consumers back to the same store, and not necessarily for a complimentary shopping experience at another vendor. Fourth, these are just coupons, and are not necessarily the most compelling offers to the consumers and are typically tied to a manufacture's product, with a number of purchasing restrictions. And fifth, there is no way to interactively transact in real time with the coupons by purchasing on a digital device. And sixth and finally, there is no way to tie the shopping patterns to a particular consumer over time and track that consumer's purchase and redemption history across multiple visits.

Systems also exist in which a group of consumers are able to aggregate their demand for a particular product/service at a particular price. In these systems, the merchant agrees to create a deal and the deal is presented to consumers. Once a sufficient number of consumers indicate their interest in the particular product/service at the particular price, the deal for the particular product/service at the particular price occurs. When the merchant of the particular product/service accepts the deal, each consumer can purchase the particular product/service at the particular price from the merchant. An example of such as system is the system provided by Tippr, Inc. Tippr also provides accelerated deals in which, as more people buy a deal for a product/service, each consumer is giving a bigger discount. Tippr.com LLC, is an online local daily deal provider that depends on a certain minimum number of users signing up before a deal is available to purchase from a local merchant. Tippr increases the discount offered to consumers as more consumers buy into the deal. However, Tippr does not have an automated way of signing up merchants, cannot prove in-store redemption, cannot perform proximity based pricing, and does not allow for consumer created deals.

Thus, it is desirable to provide a mobile voucher system and method that overcomes the above limitations of the existing systems and it is to this end that the disclosure is directed.

### BRIEF DESCRIPTION OF THE DRAWINGS

FIG. 1 illustrates an implementation of a mobile voucher system;

FIG. 2 illustrates an implementation of merchant auto-scaling that is implemented on the mobile voucher system;

FIG. 3 illustrates an example of the user interface of a consumer computing device mobile voucher application;

FIG. 4 illustrates an example of the user interface of a consumer computing device mobile digital voucher issued by the mobile voucher system;

FIG. 5 illustrates an implementation of user created deals that is implemented on the mobile voucher system; and

FIG. 6 illustrates an example of the consumer referral reward of the mobile voucher system.

### DETAILED DESCRIPTION OF ONE OR MORE EMBODIMENTS

The disclosure is particularly applicable to a mobile voucher system in which one or more smartphones (Apple iPhone, Android OS based phones, etc.) are used to interact with a mobile voucher system in a client/server type architecture over the Internet and it is in this context that the disclosure will be described. It will be appreciated, however, that the system and method has greater utility since it can be implemented using other mobile devices, may be implemented using other computer architectures and may be used for other mobile type applications that are within the scope of this disclosure.

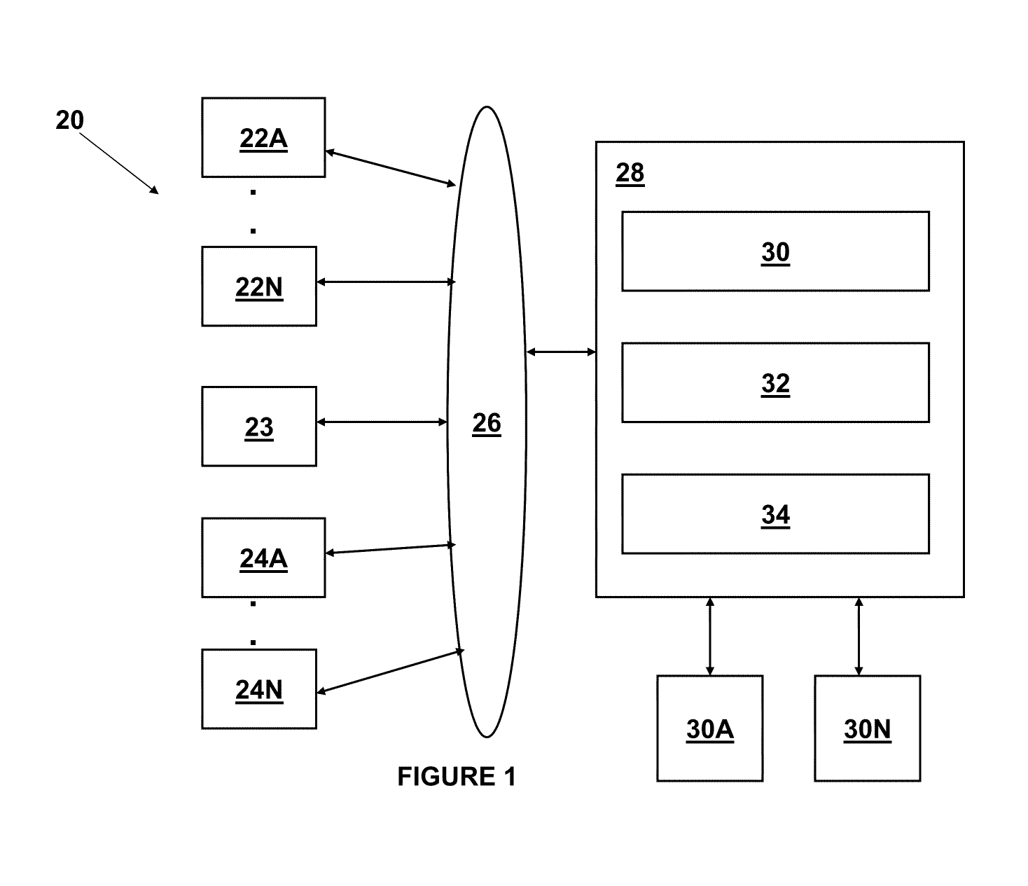

FIG. 1 illustrates an implementation of a mobile voucher system 20. The mobile voucher system 20 may have one or more consumer computing devices 22A-22N, one or more publisher systems 23 and one or more merchant systems 24A-24N that communicate with and interact over a link 26 to a mobile voucher unit 28. The one or more consumer computing devices 22A-22N may each be a processing unit based device with sufficient processing power, memory capacity and wired/wireless connectivity to communicate with and interact over the link 26 to the mobile voucher unit 28 as described below in more detail. For example, each consumer computing device may be a smartphone mobile device (such as an Apple® iPhone®, a RIM® Blackberry® device, Windows Phone 7, an Android operating system-based device and the like), a laptop computer, a desktop personal computer (PC), a tablet computer (such as the Apple® iPad® and the like) and other devices that are capable of communicating with and interacting over the link 26 to the mobile voucher unit 28. The one or more publisher systems 23 may each be a processing unit based device with sufficient processing power, memory capacity and wired/wireless connectivity to communicate with and interact over the link 26 to the mobile voucher unit 28 as described below in more detail. For example, each publisher system may be one or more server computers, a personal computer, a laptop computer, a tablet computer, a smartphone and the like. The one or more merchant systems 24A-24N may each be a processing unit based device with sufficient processing power, memory capacity and wired/wireless connectivity to communicate with and interact over the link 26 to the mobile voucher unit 28 as described below in more detail. For example, each merchant system may be one or more server computers, a personal computer, a laptop computer, a tablet computer, a smartphone and the like. Each merchant system also may be just a facsimile machine that allows the merchant to interact with the mobile voucher unit 28. The link 26 may be a wireless or wired link that may be a computer network, a cellular network, a cellular digital data network, a communications network, internet-based networks and the like. The mobile voucher unit 28 may be one or more server computers that execute the code to implement the functions and operations of the mobile voucher unit 28, one or more cloud based resources that execute the code to implement the functions and operations of the mobile voucher unit 28 or one or more hardware devices that implement the functions and operations of the mobile voucher unit 28. In one embodiment, each consumer computing device is a smartphone device, each publisher system and each merchant system is one or more server computers, the link is the Internet and the mobile voucher unit 28 is one or more server computers. Although the system in FIG. 1 has a client/server type architecture, the system also may be implemented using a SaaS architecture, a cloud based architecture and the like since the system is not limited to any particular system architecture, type of consumer computing device, type of publisher or merchant system or link.

In one implementation, each consumer computing device may have a browser application that is capable of communicating and interacting with the mobile voucher unit 28. In other implementations, each consumer computing device may have an app (a stand alone app or an app that operates inside of another app) that is capable of communicating and interacting with the mobile voucher unit 28. The publisher system(s) and merchant system (s) may similarly have browser applications or apps that is capable of communicating and interacting with the mobile voucher unit 28.

In operation, each consumer computing device, using the browser or app, may indicate an interest in a syndicated deal/voucher, purchase a voucher from the mobile voucher unit 28 and then redeem the voucher at a merchant who is a member of the mobile voucher unit 28. Each publisher system is a system that a person/business user, who wishes to generate an app (game application, commerce application, etc.) that embeds the mobile voucher app, to submit their app into which the mobile voucher app from the mobile voucher unit 28 may be integrated. Each merchant system allows the merchant to interact with the mobile voucher unit 28 and participate in the mobile vouchers that are generated by the mobile voucher unit 28. More details of the merchant system are provided in Appendix A which is incorporated herein by reference. Furthermore, more details of the published system are provided in Appendix B which is incorporated herein by reference.

In addition to providing mobile vouchers to each consumer, the mobile voucher unit 28 implements merchant auto-scaling, described below in more detail, that allows the system 20 to acquire merchants. At a high level, during the merchant auto-scaling, the system: 1) creates a deal for a merchant (without the merchant's advanced knowledge or approval); 2) determines the purchase price, redemption value and discount of the deal; 3) syndicates this deal onto its platform and presents it to the consumers; 4) get consumers to provisionally opt into the deal (in which a consumer typically provides a credit card which is held by not charged until a merchant accepts the deal as described below) until a predetermined number of consumers provisionally opt into the deal to create demand; and 5) offers the deal (mobile voucher) to one or more merchants who can then choose to take the deal. The mobile voucher unit 28 also implements consumer created deals/vouchers, described below in more detail, in which the system allows a consumer to request a new deal/voucher which the system then syndicates and provides to a merchant for the deal once there is sufficient consumer demand for the consumer created deal/voucher. The mobile voucher unit 28 also implements deal bundling, described below in more detail, in which the system is able to bundle/tie together one or more different deals/vouchers based on various information about the current voucher or the current consumer as described below in more detail.

In the implementation of the system shown in FIG. 1, the mobile voucher unit 28 may be one more server computers wherein each server computer has one or more processing units, memory and other known components of a server computer and an operating system. The mobile voucher unit 28 may have a web server/communication unit 30 that can communicate with each consumer computing device 22, each publisher system 23 and each merchant system 24 when the devices use a browser application in which web pages are sent to the devices and data is sent back to the mobile voucher unit 28 or with devices that use apps. The mobile voucher unit 28 also may have a mobile voucher manager 32 that manages and implements the merchant auto-scaling, consumer created deals and deal bundling and coordinates the interactions with the publishers and the merchants. The mobile voucher unit 28 also may have a mobile voucher commerce manager 34 that manages the commercial transactions between the consumers, merchants and/or the mobile voucher unit. The various components of the mobile voucher unit 28 described above may be each implemented as a plurality of lines of computer code that are executed by the mobile voucher unit 28. The mobile voucher unit 28 also may have one or more storage units 30 that store the data, software code, user data and the like, of the mobile voucher system. In one implementation, the one or more storage units may include a user storage unit 30A that stores the typical data of the user and a mobile voucher storage unit 30N wherein each storage unit may be a database that may be software based or hardware based.

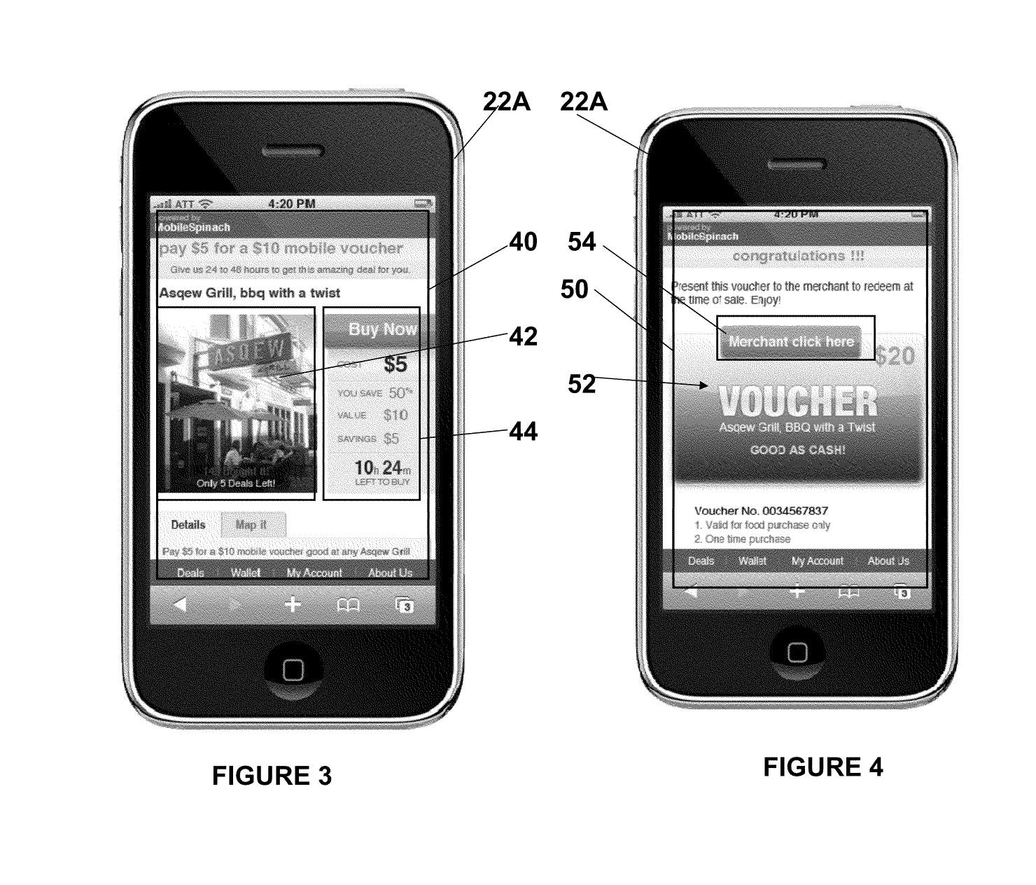

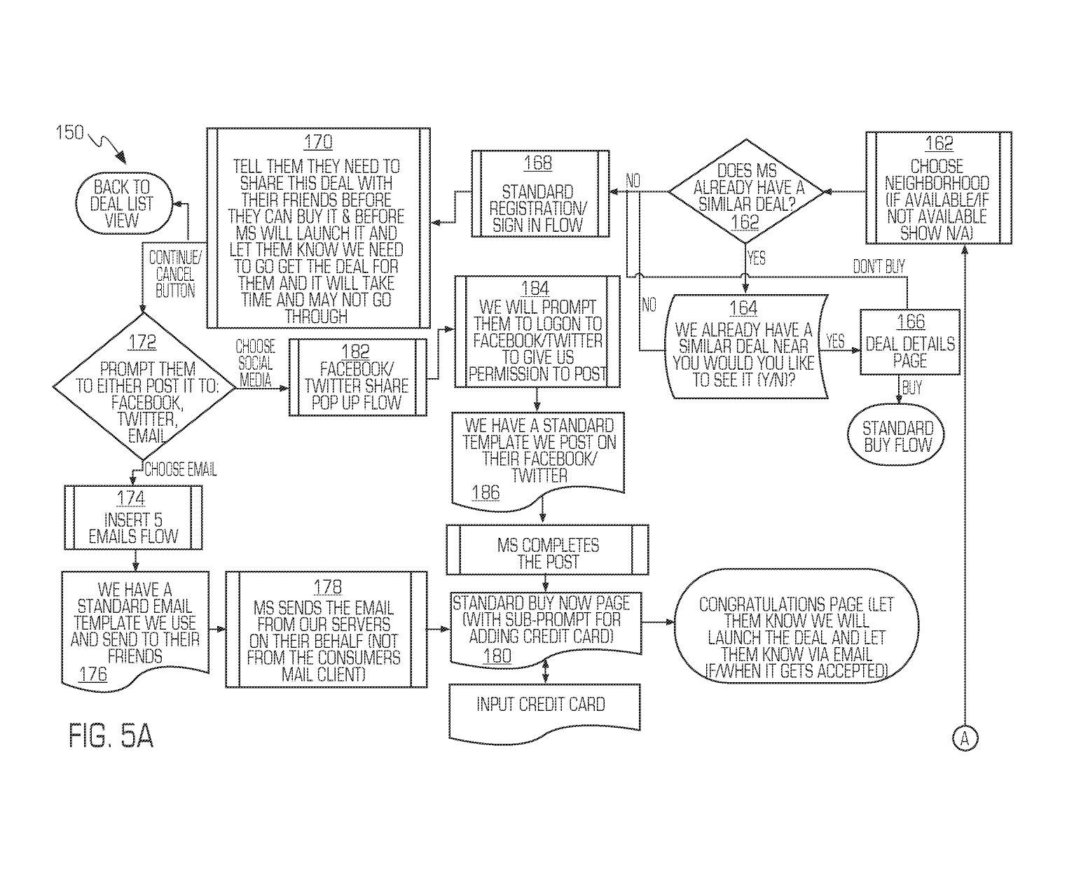

FIG. 3 illustrates an example of the user interface 40 of a consumer computing device 22A mobile voucher application and FIG. 4 illustrates an example of a user interface 50 of the consumer computing device 22A digital voucher issued by the mobile voucher system. As shown in FIG. 3, the user interface 40 displays the voucher deal to each user who has the consumer computing device 22A. Each mobile voucher user interface 40, as shown in FIG. 3, has a merchant photo/image/status portion 42 that shows the merchant photo/image for the particular deal/voucher and a status for the particular voucher when the user views the voucher (a number of deals already bought (such as 148 as shown in FIG. 3 and a number of deals/vouchers left (such as 5 in the example)). Each mobile voucher user interface 40, as shown in FIG. 3, also has a voucher details portion 44 that contains various information about the voucher/deal. For example, the voucher details portion 44 may have a “Buy Now” user interface element so that that user can buy the voucher (provisionally if the deal threshold has not been met, or if the deal has not yet been accepted by the merchant), the saving percentage associated with the voucher, the value of the voucher/deal and the savings associated with the voucher and a time left to buy the particular voucher. Once the user has bought the voucher/deal which has been approved by the particular merchant, the digital voucher user interface 50 shown in FIG. 4 appears on the device 22A. The digital voucher user interface 50 may include a digital voucher 52 that contains information about the voucher and terms and conditions of the purchased voucher. The digital voucher user interface 50 also may include a redemption user interactive interface element 54 that allows the merchant to prove redemption of the voucher. Now, the merchant auto-scaling aspect of the mobile voucher system is described in more detail.

Merchant Auto-Scaling

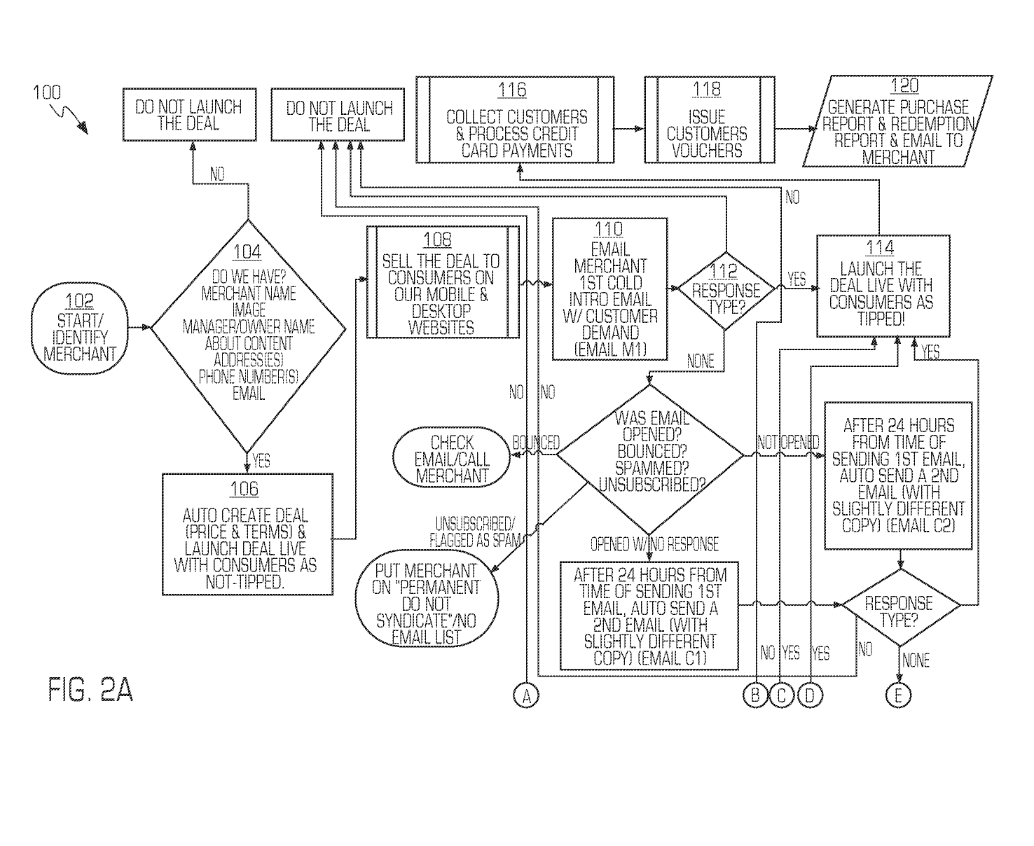

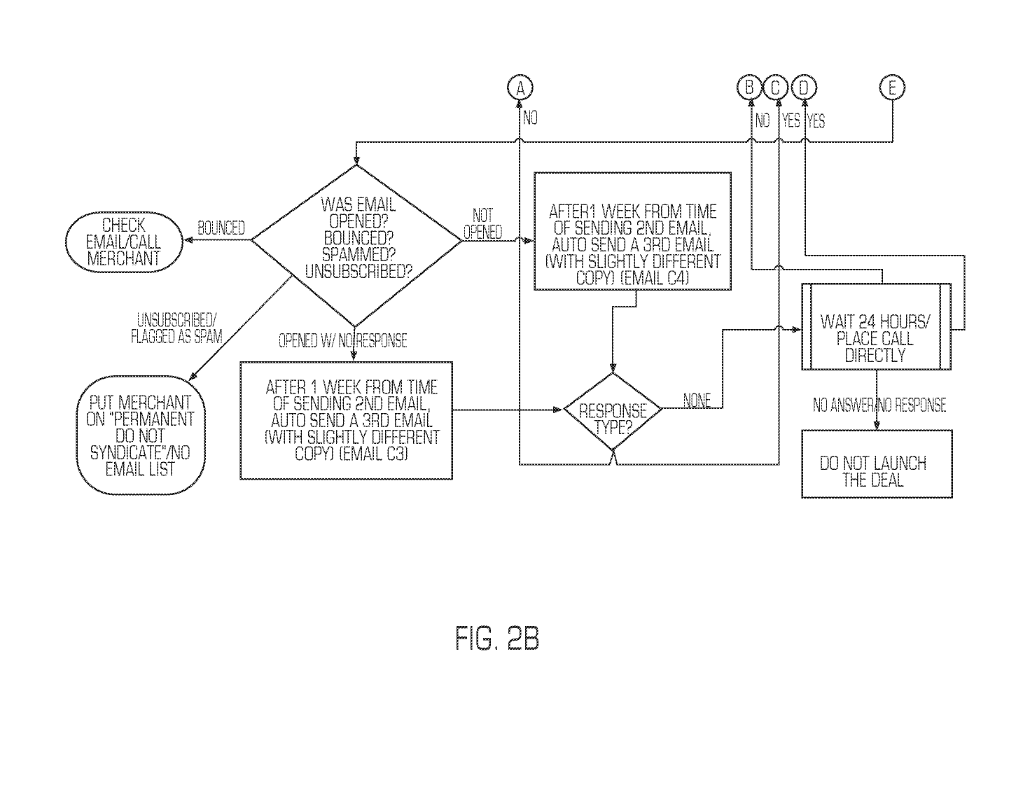

FIG. 2 illustrates an implementation of merchant auto-scaling 100 that is implemented using the mobile voucher system. Initially, the system/owner of the system identifies a merchant 102 and then determines if various information about the merchant (merchant name, image, about content, addresses, phone number(s), manager/owner name, email address, etc.) can be located (104) and the system does not launch the deal if that information cannot be located. If the information about the merchant is available, the system auto creates a deal (106) for the merchant (without the merchant's advanced knowledge or approval) in which the mobile voucher manager 32 determines a purchase price, redemption value and discount of the created deal for the merchant. The mobile voucher system determines the value and cost of the deal by classifying the merchant by industry sector. Then the typical margins and the price points of that merchant sector are determined. The range of products the merchant has to sell are also factored in. Previous consumer demand for similar merchants is also considered. These various factors are combined with our internal algorithm to determine the optimal price points and discount rate to set for the deal. For example, a coffee shop has a smaller profit margin than a large restaurant. The mobile voucher system creates a deal that is respectful of the merchant's typical margins. Example deals/offers would be: a) coffee shop, ‘pay $3 for $5 worth of food and drink; and b) larger restaurant, ‘pay $20 for $40 worth of food and drink’. The system then syndicates this deal (108) onto the system platform and presents the created deal to the consumers who use the system, such as by using mobile device apps and desktop websites, and various 3^{rd} party publisher mobile apps and desktop websites. In this manner, the mobile voucher manager 32 creates new deals without merchant approval and then presents the aggregated consumer demand to the merchant only when a sufficient number of consumers have indicated an interest in the created deal.

In the auto-scaling process, one or more consumer(s) “provisionally buys” this deal for a specific price and discount from m.MobileSpinach.com's mobile phone based application (which may or may not be embedded in other 3^{rd} party smartphone native applications, mobile web application (or web based desktop application at www.mobilespinach.com or other 3^{rd} party websites). For the created deals, Mobile Spinach is the merchant of record. Typically the deals are in the form of pay $10 for a $20 voucher that you can use to buy $20 worth of any product or service at the specific local merchant. An example of a created deal is shown in FIG. 3 that is an example of the user interface of a mobile device mobile voucher application. During the creation of sufficient consumer interest in the created deal, each consumer'(s) credit card is “held”/stored but not charged for deals that do not have sufficient interest yet and/or are still pending approval from a local merchant. For deals that are already approved, the consumer's credit card is charged right away.

The mobile voucher manager 32 continues to sell the deal/accrue customer demand until it reaches a deal threshold (that may be a certain number of 1) deals sold or 2) $ amount of deals sold) and the thresholds are determined by the mobile voucher manager 32. These values are set internally by the mobile voucher manager. Factors that affect these values are the type of merchant, the rate at which the deal is being bought by consumers, the discount being offered, the day of the week, and whether or not this merchant has been featured by the mobile voucher manager before, and the related values that other similar merchants have agreed to in the past. For example, if previously fitness clubs typically are comfortable accepting 100 deals sold totally $2000 in value, then the mobile voucher manager would continue to sell the deal until 100 units have been sold and $2000 of revenues have been collected from the consumers.

Once the deal threshold has been reached for a particular deal, the merchant is then automatically contacted by the mobile voucher manager 32 and asked if they would like to accept these customer(s) and the deal that was offered to the customer(s). The mobile voucher manager may contact several similar merchants at the same time to see if they want to be the first to accept the offer and get the consumers and their revenues. In this case the mobile voucher manager would structure the deal presentation to the consumers to show that there are several potential merchants which may accept the offer. Approaching several similar merchants at the same time to compete over the same customers would have the benefit of increasing the likelihood that the deal will be accepted by at least one merchant and that the consumer demand is fulfilled. In the case that multiple merchants accept the offer, the demand will be awarded to the merchant that first accepted the offer, and the mobile voucher manager would initiate new deals for new customers for the other merchants who subsequently accepted. The mobile voucher manager 32 can contact the merchant via automated email and/or fax and/or phone. As shown in FIG. 2, the process may include communicating the deal to the merchant (email or fax or other forms) (110) and then determining the response (112) from the merchant. The mobile voucher manager 32, as shown in detail in FIG. 2, may have a process of repeated communications to determine if the merchant will accept the deal. In some cases, the merchant may be moved to a list of merchants for which deals are no longer created. In a usual case, the mobile voucher manager 32 may allow 48 hours for a response from the merchant. However, a longer period can be given for the merchant to respond as shown particularly in FIG. 2. Often times, the mobile voucher manager 32 will re-contact the merchant via email/fax until the merchant responds. Furthermore, if the merchant opens the email and clicks on the custom link/or follows the instructions on the fax, they will be directed to a desktop based website specifically for that merchant in which the merchant can register to approve or decline the deal. The merchant specific website has a full dashboard that can allow the merchant to monitor their sales of the deal, the in-store redemptions of the deal, and re-launch the deal or create new deals. The auto-scaling process permits any deal to be abandoned based on various factors.

If the merchant agrees to the above, then the deal goes live (114) and the previously stored/held consumer(s) credit cards are now charged (116) for the amount of the deal specified and the consumer receives a digital voucher (118) and the funds from the consumer(s) go into a Mobile Spinach bank account. The mobile voucher manager 32 continues to sell the deal to new consumers if the merchant approves that, or it will stop selling it to new consumers and just fulfill the ones already sold if the merchant only agrees to that.

If the merchant declines to accept the created deal, then the deal is revoked and the consumer's credit cards are not charged the money for the deal is no longer held on their credit card. In the mobile voucher system, each consumer is notified of the outcome of the deal (whether accepted or declined) via email or can see the status of the deal on the Mobile Spinach application the next time they log back in.

As described above, for deals that are accepted/approved by the merchant, the consumers are issued a digital voucher on their smartphone (see FIG. 4 for example that shows an example of the user interface of a mobile device digital voucher issued by the mobile voucher system) and each consumer can redeem the deal.

When a user who has a digital voucher is in a merchant location and wants to redeem the digital voucher, the user brings up the user interface of the digital voucher as shown in FIG. 4. The merchant then clicks on the “Merchant Click Here” area/button of the user interface which then indicates that the merchant is accepting the redemption of the digital voucher. When the deal is redeemed, the merchant is paid its split on a per consumer basis.

The system also regularly email reports to merchants (120) showing the particular merchant how many vouchers have been redeemed and how many new sales they have. The system also measures the redemption and sales rate of that particular merchant. In the system, merchants who sell well to consumers are asked regularly to re-launch new deals and merchants who don't sell well are eventually removed from the Mobile Spinach platform.

User Created Deals

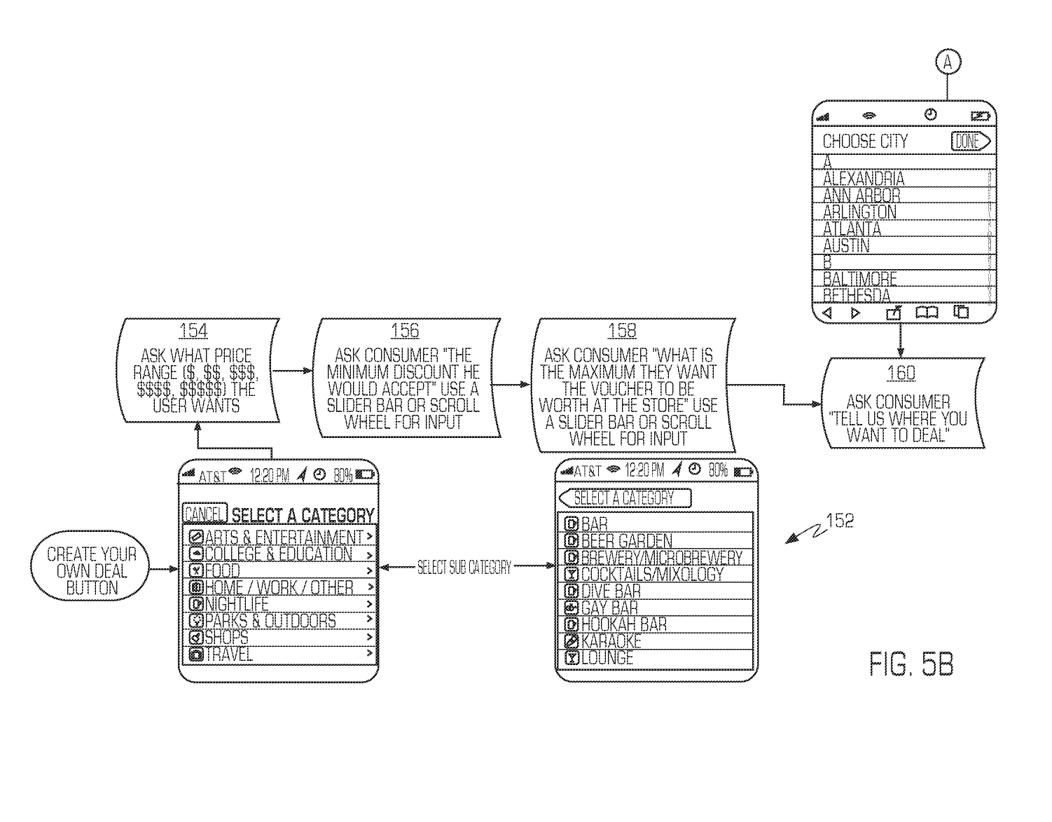

The mobile voucher system (and in particular the mobile voucher manager 32) may also implement user created deals whose process 150 is shown in FIG. 5. A consumer can access the user created deals process 150 from a “create your own deal” button that is part of the user interface of the mobile application, web-browser based mobile application and/or desktop application. The user then selects a category and subcategory for the user created deal from a set of user interfaces (152) and the system then asks for a price range of the deal that the user wants (such as $, $$, $$$, $$$$, $$$$$) (154) and the minimum discount that the user would accept (156) wherein the user interface may have a slider bar or scroll wheel to allow the user to select the minimum discount. The mobile voucher manager 32 then asks user to specify the maximum amount the voucher should be worth at the merchant (158) wherein the user interface may have a slider bar or scroll wheel and the location of the deal (160) in which the user can choose a city from a user interface element. The mobile voucher manager 32 may allow the user to specify a neighborhood, such as the Peninsula in the Bay Area, if that option is available for the particular area.

Once the system has these pieces of information about the user created deal, the mobile voucher manager 32 then determines if the system already has a similar deal (162). If there is a similar deal, the mobile voucher manager 32 notifies the user (164) and, if the user wants to see the similar deal, is presented with the similar deal details (166) so that the user can become a consumer of the existing deal. If the user wants to continue with the user created deal, the user is asked to register/log in (168) and the system informs the user that: 1) he/she needs to share this deal with their friends before they can buy it and before the mobile voucher system will launch it to a merchant; and 2) that the mobile voucher system has to go get the deal for them and it will take time and may not be accepted by the merchant(s) (170). At this point, if the user does not select to continue, the user is returned to the deal listing user interface.

If the user wants to continue with the user created deal, the system prompts the user to post the deal on Facebook, Twitter or via email (172). If the user selects to use email, the system starts an email flow, provides an email template to the user and send the emails on behalf of the user (174-178) so that their friends are directed to a buy now page (180) of the system. If the user selects a social media outlet, a social media flow is started in which the user is prompted to log into a social media site and the system has a template for the post (182-186) so that their friends are directed to a buy now page (180) of the system.

Thus, the mobile voucher system provides a mechanism to allow the user to create their own deal, check the user created deal against the existing deals and cause the user to email/socially post online the deal to their friends to create interest for the user created deal.

Consumer Referral Rewards

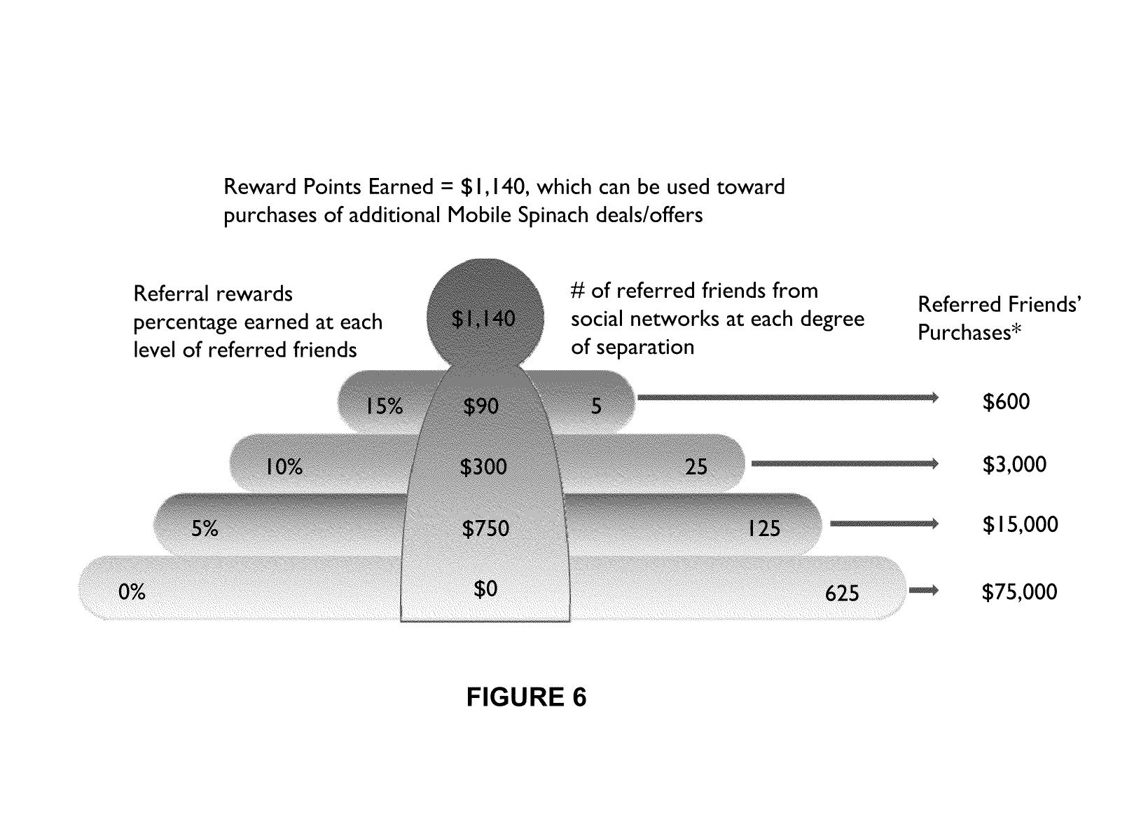

This is a method of turning the end consumer into a distribution channel targeting their friends based on integration with popular social networks, which also creates switching costs for the end consumer(s). This system incentivizes consumers who purchase a deal from the mobile voucher system, to share the fact that they made this purchase with their friends, colleagues, and other “followers” they have on various 3rd party social media platforms such as Facebook and Twitter for example. The consumer referral rewards method described below may be implemented in a consumer referral rewards unit/module that is part of the mobile voucher system. The mobile voucher system provides automated integration between itself and these various 3rd party social media platforms via a set of social media interfaces/APIs that are part of the mobile voucher system. This automated integration allows the end consumer/user of the voucher system and easy, direct, and seamless method to post their purchases and/or voucher redemptions on these social media platforms. The automated integration provides the end consumer/user (which will be referred to as the “Prime User” for the purposes of this illustration) a unique traceable url based hyper link that is assigned only to that end consumer/user. This hyper link is then posted on the user's social media sites/accounts, such as their Facebook page or Twitter feed. The mobile voucher system is able to track this hyper link. The mobile voucher system can track how many times and when this link was clicked by that user's social media friends and “followers”. It can also track which friends and “followers” signed up to and/or bought deals from the mobile voucher system. An example of the consumer referral reward of the mobile voucher system is shown in FIG. 6.

When the social media friends of this Prime User purchase deals from the mobile voucher system, the mobile voucher system can track the amount of purchases these social media friends generated. The mobile voucher system can also track which “degree of separation” these social media friends are from the Prime User. For example if the Prime User posts the unique traceable hyper link generated by the mobile voucher system on their Facebook page, and 5 of their immediate Facebook friends buy a deal from the mobile voucher system from this unique hyper link, and then each of these 5 friends (which will be referred to as the “Level 1 Friends” for the purposes of this illustration) in turn post new unique traceable link generated by the mobile voucher system onto their own Facebook pages respectively, and in turn, each of these friends has 5 new friends each (which will be referred to as the “Level 2 Friends” for the purposes of this illustration) that buy a deal from the mobile voucher system from these unique hyper links, and so on. The voucher system will pay the Prime User a commission in the form of reward points based on the purchases of these various Level 1 and Level 2 Friends up to Level 4 Friends (however, the number of Levels is subject to change). At each increasing Level from the Prime User, the percent of commission that is generated decreases until it reaches zero. So for example, the Prime User earns a 15% commission from his Level 1 Friends, and a 10% commission from his Level 2 Friends, and a 5% commission from his Level 3 Friends, and 0% commission from his Level 4 Friends. Also, each new member who joins becomes a Prime User in their own right and enjoys the same commissions from each Friend Level of their social networks. This means that the same purchasing user from a particular Friend Level may generate commissions for one or more Prime Users, albeit at always different staggered commission rates for each Prime User (this is done to avoid overlapping commissions and to keep the maximum total commission payable from the purchases of any one user to at most 30%). Commissions are generated only on actual products and or services purchased from deals sold on the mobile voucher system.

The Prime Users will be able to track the number of people that have signed up from their social media posts. They will also be able to track their total commissions earned. The commissions earned by the Prime User(s) can be thought of as reward points similar to airline miles reward programs. These reward points can only be used towards the purchase of additional deals/vouchers from the mobile voucher system. They cannot be paid out or withdrawn as cash. These reward points serve to 1. incentivize consumers to promote the mobile voucher system to their friends, 2. create inherent switching costs that keep consumers loyal to the mobile voucher system, and 3. and drive repeat business to the local merchants that are members of the mobile voucher system.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A mobile voucher system, comprising:
one or more consumer computing devices;
a mobile voucher unit that is capable of being connected to and interacting with each of the one or more consumer computing devices over a link;
the mobile voucher unit having a mobile voucher manager that creates a new deal having a purchase price, a redemption value and a discount of the new deal for a particular merchant, that syndicates the new deal to a plurality of consumers to determine a level of interest of the plurality of consumers wherein an interested user participates in the new deal, that presents the new deal to the particular merchant when a deal threshold is met and, when the merchant accepts the new deal, that provides a digital voucher to the consumer computing device of each user who participated in the new deal; and
each consumer computing device that displays the digital voucher received from the mobile voucher unit and allows the user of the consumer computing device to redeem the digital voucher at the particular merchant.

2. The system of claim 1, wherein each consumer computing device is one of a smartphone mobile device, a laptop computer and a tablet computer.

3. The system of claim 1, wherein the mobile voucher manager is a computer with a processor executing a plurality of lines of computer code.

4. The system of claim 1, wherein the mobile voucher manager provides user generated deals that allows a first user to propose a new deal for a particular merchant.

5. The system of claim 1, wherein the mobile voucher manager notifies that the first user that a similar deal to the user new deal is already stored in the mobile voucher unit.

6. The system of claim 1, wherein the mobile voucher unit further comprises consumer referral rewards unit that incentives the consumer who received the digital voucher to share the new deal with a set of friends using social media systems.

7. The system of claim 1, wherein the consumer referral rewards unit generates a traceable hyperlink that is shared with the set of friends.

8. The system of claim 1, wherein each consumer computing device further comprises a processing unit and one of a browser application being executed by the processing unit to interact with the mobile voucher unit and an app executed by the processing unit to interact with the mobile voucher unit.

9. A method for providing a mobile voucher with one or more consumer computing devices and a mobile voucher unit that is capable of being connected to and interacting with each of the one or more consumer computing devices over a link, the method comprising:
creating, using a mobile voucher manager of the mobile voucher unit, a new deal having a purchase price, a redemption value and a discount of the new deal for a particular merchant;
syndicating, using the mobile voucher manager of the mobile voucher unit, the new deal to a plurality of consumers to determine a level of interest of the plurality of consumers wherein an interested user participates in the new deal;
presenting, using the mobile voucher manager of the mobile voucher unit, the new deal to the particular merchant when a deal threshold is met; and
providing, using the mobile voucher manager of the mobile voucher unit, when the merchant accepts the new deal, a digital voucher to the consumer computing device of each user who participated in the new deal.

10. The method of claim 9 further comprising displaying, on each consumer computing device, the digital voucher received from the mobile voucher unit and redeeming, using the consumer computing device, the digital voucher at the particular merchant.

11. The method of claim 9 further comprising providing, using the mobile voucher manager of the mobile voucher unit, user generated deals that allows a first user to propose a new deal for a particular merchant.

12. The method of claim 11 further comprising notifying, using the mobile voucher manager of the mobile voucher unit, the first user that a similar deal to the new user deal is already stored in the mobile voucher unit.

13. The method of claim 9 further comprising incentivizing, using a consumer referral rewards unit of the mobile voucher unit, the consumer who received the digital voucher to share the new deal with a set of friends using social media systems.

14. The method of claim 13 further comprising generating, using the consumer referral rewards unit of the mobile voucher unit, a traceable hyperlink that is shared with the set of friends.

15. A mobile voucher unit that is part of a mobile voucher system that interacts with one or more consumer computing devices, the mobile voucher unit comprising:
a computer system;
a mobile voucher manager executed by the computer system, the mobile voucher manager having a plurality of lines of computer code that perform the processes of:
creating a new deal having a purchase price, a redemption value and a discount of the new deal for a particular merchant, syndicating the new deal to a plurality of consumers to determine a level of interest of the plurality of consumers wherein an interested user participates in the new deal, presenting the new deal to the particular merchant when a deal threshold is met and, when the merchant accepts the new deal, providing a digital voucher to the consumer computing device of each user who participated in the new deal so that each consumer computing device can redeem the digital voucher at the particular merchant.

16. The mobile voucher unit of claim 15, wherein the mobile voucher manager provides user generated deals that allows a first user to propose a new deal for a particular merchant.

17. The mobile voucher unit of claim 16, wherein the mobile voucher manager notifies that the first user that a similar deal already is stored in the mobile voucher unit.

18. The mobile voucher unit of claim 15 further comprising consumer referral rewards unit that incentives the consumer who received the digital voucher to share the new deal with a set of friends using social media systems.

19. The mobile voucher unit of claim 18, wherein the consumer referral rewards unit generates a traceable hyperlink that is shared with the set of friends.
